(19) United States
(12) Patent Application Publication
(10) Pub. No.: US 2023/0357585 A1
(43) Pub. Date: Nov. 9, 2023

(54) LOW SHEEN DEEP BASE COATING COMPOSITION

(71) Applicant: Rohm and Haas Company, Collegeville, PA (US)

(72) Inventors: James C. Bohling, Lansdale, PA (US); Sarah D. Hann, Phoenixville, PA (US); Philip R. Harsh, Birdsboro, PA (US); Partha S. Majumdar, Harleysville, PA (US); Teresa A. Phillips, Westhampton, NJ (US); Thomas W. Suder, Perkasie, PA (US)

(21) Appl. No.: 18/029,383

(22) PCT Filed: Oct. 19, 2021
(86) PCT No.: PCT/US2021/055544

§ 371 Date: Mar. 30, 2023

Related U.S. Application Data
(63) Continuation of application No. 63/106,925, filed on Oct. 29, 2020.

(51) Int. Cl. C09D 7/40; C09D 7/42; C09D 7/61; C09D 133/08

(52) U.S. Cl. CPC C09D 7/70; C09D 7/69; C09D 7/42; C09D 7/61; C09D 133/08; C08K 3/11

(57) ABSTRACT

The present invention relates to a composition comprising an aqueous dispersion of a) polymer particles having a z-average particle size in the range of from 80 nm to 500 nm; b) polymeric crosslinked organic microspheres having a D₅₀ particle size in the range of from 1 μm to 30 μm; c); a colorant and d) a zinc or zirconium compound. The composition of the present invention is useful for reducing leaching from a coating prepared from a deep base, low sheen paint formulation.

### BACKGROUND OF THE INVENTION

The present invention relates to a low sheen deep base composition that is useful for preparing a paint exhibiting a reduction in leaching of water-soluble materials.

Deep base paints in flat and egg-shell sheen contain high level of colorants (8 to 16 oz of colorant per gallon of paint). When the deep base paint is applied to a substrate and allowed to dry, exposure to water droplets over time can cause severe water staining, which is attributed to leaching of water-soluble materials from the paint film such as surfactants, dispersants, rheology modifiers, water-soluble oligomers, and defoamers. Water staining is even more likely to occur shortly after the paint is applied to a substrate before film formation is incomplete and water is capable of penetrating the surface of the coating with concomitant leaching of the water-soluble materials. Leaching is especially pronounced in low sheen paint formulations because the substantial amounts of non-film forming extenders required to create low sheen paints create a more porous film that is even more susceptible to the exudation of water-soluble materials. Accordingly, it would be an advance in the field of low sheen paint formulations to find a way to reduce the level of water-soluble exudation.

### SUMMARY OF THE INVENTION

The present invention addresses a need in the art by providing a composition comprising an aqueous dispersion of a) polymer particles having a z-average particle size in the range of from 80 nm to 500 nm; b) polymeric crosslinked organic microspheres having a D₅₀ particle size in the range of from 1 μm to 30 μm; c) a colorant and d) a zinc or zirconium compound; wherein, based on the weight of the composition, the concentration of the polymer particles is in the range of from 10 to 40 weight percent; the concentration of the polymeric crosslinked organic microspheres is in the range of from 5 to 35 weight percent; the concentration of the colorant is in the range of from 5 to 25 weight percent; and the concentration of the zinc or zirconium compound is in the range of from 0.1 to 10 weight percent. The composition of the present invention is useful in a deep base, low sheen paint formulation.

### DETAILED DESCRIPTION OF THE INVENTION

The present invention is a composition comprising an aqueous dispersion of a) polymer particles having a z-average particle size in the range of from 80 nm to 500 nm; b) polymeric crosslinked organic microspheres having a D₅₀ particle size in the range of from 1 μm to 30 μm; c) a colorant and d) a zinc or zirconium compound; wherein, based on the weight of the composition, the concentration of the polymer particles is in the range of from 10 to 40 weight percent; the concentration of the polymeric crosslinked organic microspheres is in the range of from 5 to 35 weight percent; the concentration of the colorant is in the range of from 5 to 25 weight percent; and the concentration of the zinc or zirconium compound is in the range of from 0.1 to 10 weight percent.

The polymer particles are preferably acrylic based, meaning these polymer particles comprise at least 30 weight percent, based on the weight of the polymer particles, of structural units of one or more methacrylate monomers such as methyl methacrylate and ethyl methacrylate, and/or one or more acrylate monomers such as ethyl acrylate, butyl acrylate, 2-propylheptyl acrylate, and 2-ethylhexyl acrylate. The acrylic-based polymers may also include structural units of ethylenically unsaturated acid monomers such as methacrylic acid, acrylic acid, and itaconic acid, or salts thereof, as well as other non-acrylate or methacrylate monomers such as styrene and vinyl acetate. As used herein, the term “structural unit” is used herein to describe the remnant of the recited monomer after polymerization. For example, a structural unit of methyl methacrylate is as illustrated:

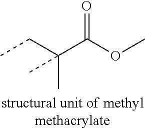

where the dotted lines represent the points of attachment of the structural unit to the polymer backbone.

The concentration of the polymer particles is in the range of from 10, preferably from 15 weight percent, to 35, more preferably to 30 weight percent, based on the weight of the composition.

Preferably, the average particle size of the polymer particles is in the range of from 100 nm to 300 nm, more preferably to 250 nm as measured using a dynamic light scattering analyzer.

The polymeric organic microspheres are crosslinked and preferably multistage, preferably with a first stage comprising a low T_{g} (≤20° C., preferably <10° C., and more preferably <0° C., as calculated by the Fox equation) homo- or copolymer that is crosslinked to provide resiliency and no diffusion to the substrate; and a high T_{g} second stage (≥30° C., preferably greater than 50° C., as calculated by the Fox equation) to provide microspheres that are not film-forming at room temperature. Preferably, at least 50, more preferably at least 70, and most preferably at least 80 weight percent of the crosslinked first stage comprises structural units of I) butyl acrylate or ethyl acrylate or a combination thereof; and II) a multiethylenically unsaturated nonionic monomer such as allyl methacrylate, allyl acrylate, divinyl benzene, trimethylolpropane trimethacrylate, trimethylolpropane triacrylate, butylene glycol (1,3) dimethacrylate, butylene glycol (1,3) diacrylate, ethylene glycol dimethacrylate, or ethylene glycol diacrylate. Preferably, the ratio of I:II is in the range of from 99.5:0.5 to 90:10; preferably, methyl methacrylate homopolymer comprises at least 60, more preferably at least 80, and most preferably 100 weight percent of the second stage.

The polymeric organic multistage crosslinked microspheres preferably having an average particle size (technically, a median weight average particle size, D₅₀) in the range of from 2 μm, more preferably from 4 μm, to preferably 25 μm, more preferably to 15 μm, and most preferably to 13 μm, as measured using a Disc Centrifuge Photosedimentometer, as described hereinbelow. The concentration of the polymeric organic microspheres is in the range of from 5, preferably from 10, and preferably from 15 weight percent to 35, preferably to 30 weight percent, based on the weight of the composition. The weight-to-weight ratio of polymer particles to polymeric organic multistage crosslinked microspheres is preferably in the range of from 80:20, more preferably from 70:30, and most preferably from 65:35, to 40:60, more preferably to 50:50, and most preferably to 55:45.

Aqueous dispersions of multistage crosslinked microspheres can be prepared in a variety of ways, including those described in US 2013/0052454; U.S. Pat. Nos. 4,403,003; 7,768,602; 7,829,626; and US 2019/0185687 A1 paragraphs [0014] to [0044], and [0052].

The colorant is a non-white colorant and may be organic or inorganic. Examples of organic colorants include phthalocyanine blue, phthalocyanine green, monoarylide yellow, diarylide yellow, benzimidazolone yellow, heterocyclic yellow, quinacridone magenta, quinacridone violet, organic reds, including metallized azo reds and nonmetallized azo reds. Inorganic colorants include carbon black, lampblack, black iron oxide, yellow iron oxide, brown iron oxide, and red iron oxide. The concentration of the colorant is preferably in the range of from 5, preferably from 8 percent, more preferably from 10, to 25, more preferably to 20 weight percent, based on the weight of the composition.

The concentration of the zinc or zirconium compound is preferably in the range of from 0.2, more preferably from 0.5, and most preferably from 1 weight percent, to preferably 8, and more preferably to 5 weight percent, based on the weight of the composition. As used herein, the term “zinc compound” refers to a compound containing zinc in the +2 oxidation state. Examples of suitable zinc compounds include ZnO, Zn(NH₃)₂(CO₃)₂, ZnCl₂, ZnSO₄, and Zn(OAc)₂. Zinplex 15 Zinc Ammonium Carbonate is an example of a commercially available Zn(NH₃)₂(CO₃)₂ compound.

Similarly, a “zirconium compound” refers to a compound containing zirconium in the +4 oxidation state. Examples of suitable zirconium compounds include ZrO₂, ZrCl₄, ZrBr₄, Zr(OAc)₄, Zr(SO₄)₂, and Zr(NH₃)₂(CO₃)₂(OH)₂. Bacote 20 Zirconium Ammonium Carbonate is an example of a commercially available Zr(NH₃)₂(CO₃)₂(OH)₂ compound.

The composition of the present invention may additionally comprise wax particles such as polyethylene (PE) wax particles of the formula:

—(CH₂CH₂)ₙ—

where n is from 72 to 360.

The PE wax can be a low density PE wax, a linear low density PE wax, or a high density PE wax. If present, the concentration of the polyethylene wax is preferably in the range of from 0.1 to 3 weight percent, based on the weight of the composition. The average particle size as measured using dynamic light scattering is preferably in the range of from 0.3 μm, more preferably from 0.8 μm, to preferably 20 μm, more preferably to 15 μm, and most preferably to 10 μm.

The composition of the present invention advantageously comprises one or more additional additives such as rheology modifiers, defoamers, neutralizing agents, surfactants, organic opacifying pigments, and dispersants.

The composition of the present invention preferably comprises a substantial absence of extenders. As used herein, “a substantial absence of extenders” refers less than 10, more preferably less than 5, more preferably less than 1, and most preferably 0 pigment volume concentration (PVC) of any white, translucent, or semi-transparent inorganic particulate filler, with the exception of zinc- and zirconium-containing compounds, that does not impart a significant (non-white) color or hue. Thus, the composition comprises a substantial absence of TiO₂; BaSO₄; silicates and aluminosilicates such as talc, clay, mica, and sericite; CaCO₃; nepheline; feldspar; wollastonite; kaolinite; dicalcium phosphate; and diatomaceous earth.

As used herein, extender PVC is defined by the following equation:

$$P V C = [ \frac{Vol Solids ( Extender )}{Total Vol Solids} ] \times 100$$

where “total solids” includes TiO₂ (if present), extender, polymer particles, and microspheres, as well as other solids (e.g., opaque polymers) that constitute the volume of the final dried coating.

The composition preferably further comprises less than 0.4, more preferably less than 0.2, more preferably less than 0.1, and most preferably 0 weight percent of a dihydrazide or a polyamine or adducts thereof. As used herein, “adducts thereof” refer to the reaction product of a dihydrazide or a polyamine and a carbonyl containing compound such as formaldehyde.

It has been discovered that the composition of the present invention is useful for the preparation of deep base low sheen paint formulations that form coatings with reduced exudation of water-soluble materials.

### EXAMPLES

### Intermediate Example—Preparation of Polymeric Organic Crosslinked Microspheres

The aqueous dispersion of multistage polymeric organic crosslinked microspheres used in the following examples was prepared as described in US 2019/185687, Intermediate Example 2 [para 0060], and adjusted to 43.5% solids. The particle size was 8.7 μm as measured by DCP, as described in para [0063] of US 2019/185687.

Table 1 is a listing of materials and amounts used to make low gloss deep base paints. Acrylic Emulsion refers to RHOPLEX™ VSR1049LOE Acrylic Emulsion (50% solids); PE Wax refers to Michem Guard 1350 PE Wax; Defoamer refers to Byk-024 Defoamer; RM-1600 refers to ACRYSOL™ RM-1600 Rheology Modifier; RM-725 refers to ACRYSOL™ RM-725 Rheology Modifier; Colorant refers to Colortrend 808 Red Iron Oxide Colorant; Zn Compound refers to Zinplex 15 Zinc Ammonium Carbonate; and Zr Compound refers to Bacote 20 Zirconium Ammonium Carbonate. All amounts are expressed as weight percentages. RHOPLEX and ACRYSOL are Trademarks of The Dow Chemical Company or Its Affiliates.

TABLE 1
Deep Base Paint Formulation

| Material | Comp Ex 1 | Ex 1 | Ex 2 | Ex 3 | Ex 4 |
|---|---|---|---|---|---|
| Acrylic | 44.62 | 43.97 | 43.97 | 43.56 | 43.56 |
| Emulsion | | | | | |
| Intermediate | 35.69 | 35.16 | 35.16 | 34.82 | 34.82 |
| Example | | | | | |
| PE Wax | 0.79 | 0.77 | 0.77 | 0.77 | 0.77 |
| Defoamer | 0.12 | 0.11 | 0.11 | 0.11 | 0.11 |
| Ammonia | 0.06 | 0.05 | 0.05 | 0.05 | 0.05 |
| RM-1600 | 1.29 | 1.26 | 1.26 | 1.23 | 1.23 |
| RM-725 | 0.46 | 0.45 | 0.45 | 0.44 | 0.44 |
| Water | 7.89 | 7.78 | 7.78 | 7.70 | 7.70 |
| Colorant | 9.09 | 8.96 | 8.96 | 8.87 | 8.87 |
| Zn Compound | 0.00 | 1.48 | 0.00 | 2.44 | 0.00 |
| Zr Compound | 0.00 | 0.00 | 1.48 | 0.00 | 2.44 |

Testing Method:

Method ASTM D7190 was followed to evaluate resistance towards staining caused by the leaching of water soluble materials. Paints were drawn down over Black Leneta Vinyl charts using a 7-mil Dow drawdown bar. Each drawdown was divided into three sections to carry out two tests at 1 day and 4 days of drying. Coatings were allowed to dry at 77° F. (25° C.) and 50% relative humidity before testing. Water droplets (0.1 mL) were placed across the top of the first designated area of the coating and allowed to stand for 10 min. After 10 min, charts were lifted to a vertical position, which allowed water to run down. Visible water staining was evaluated after drying overnight and rated subjectively on a scale from 1 to 5, where 5 was rated as best and 1 was rated as worst. A rating of 3 or better was considered acceptable. Table 2 shows the water soluble material leaching ratings at 1 day and 4 days for the paints subjected to the water staining method.

TABLE 2
Water Soluble Material Leaching Rating

| | Leaching Rating | |
|---|---|---|
| Sample | 1 d | 4 d |
| Comp Ex 1 | 1.5 | 2 |
| Ex 1 | 4 | 4 |
| Ex 2 | 3 | 3 |
| Ex 3 | 4.5 | 4.5 |
| Ex 4 | 3.5 | 3.5 |

The data show that the paints containing the zinc or zirconium compound show acceptable leach ratings, while the paint without the zinc or zirconium compound failed.

1. A composition comprising an aqueous dispersion of a) polymer particles having a z-average particle size in the range of from 80 nm to 500 nm; b) polymeric crosslinked organic microspheres having a D₅₀ particle size in the range of from 1 μm to 30 μm; c) a colorant and d) a zinc or zirconium compound; wherein, based on the weight of the composition, the concentration of the polymer particles is in the range of from 10 to 40 weight percent; the concentration of the polymeric crosslinked organic microspheres is in the range of from 5 to 35 weight percent; the concentration of the colorant is in the range of from 5 to 25 weight percent; and the concentration of the zinc or zirconium compound is in the range of from 0.1 to 10 weight percent.

2. The composition of claim 1 which further comprises less than 10 PVC of an inorganic extender; wherein the weight-to-weight ratio of polymer particles to polymeric organic multistage crosslinked microspheres is in the range of from 80:20 to 40:60.

3. The composition of claim 2 wherein the concentration of polymer particles is in the range of from 15 to 35 weight percent, based on the weight of the composition, and the concentration of the polymeric crosslinked organic microspheres is in the range of from 10 to 30 weight percent, based on the weight of the composition, wherein the concentration of the inorganic extender is less than 5 PVC.

4. The composition of claim 2 which further comprises less than 0.4 weight percent of dihydrazides and polyamines and adducts thereof; wherein the weight-to-weight ratio of polymer particles to polymeric organic multistage crosslinked microspheres is in the range of from 70:30 to 50:50.

5. The composition of claim 3 wherein the concentration of the colorant is in the range of from 8 to 20 weight percent, based on the weight of the composition;
the concentration of the zinc or zirconium compound is in the range of from 0.2 to 8 weight percent, based on the weight of the composition; and the composition comprises less than 0.4 weight percent of dihydrazides and polyamines and adducts thereof; wherein the weight-to-weight ratio of polymer particles to polymeric organic multistage crosslinked microspheres is in the range of from 70:30 to 50:50.

6. The composition of claim 4 wherein the colorant is phthalocyanine blue, phthalocyanine green, monoarylide yellow, diarylide yellow, benzimidazolone yellow, heterocyclic yellow, quinacridone magenta, quinacridone violet, organic reds, carbon black, lampblack, black iron oxide, yellow iron oxide, brown iron oxide, or red iron oxide; wherein the concentration of the zinc or zirconium compound is in the range of from 0.5 to 5 weight percent, based on the weight of the composition;
wherein the concentration of the colorant is in the range of from 8 to 20 weight percent, based on the weight of the composition; and the composition comprises less than 0.2 percent of dihydrazides and polyamines and adducts thereof.

7. The composition of claim 5 wherein the composition further comprises from 0.1 to 3 weight percent, based on the weight of the composition, of a polyethylene wax of the formula:
—(CH₂CH₂)ₙ—
where n is from 72 to 360.

8. The composition of claim 6 which comprises 0 PVC of an inorganic extender and 0 weight percent of dihydrazides and polyamines and adducts thereof.

9. The composition of claim 1 which further comprises one or more additional materials selected from the group consisting of rheology modifiers, defoamers, surfactants, organic opacifying pigments, and dispersants.

10. The composition of claim 1 which further comprises a rheology modifier, a defoamer, and a surfactant.
